(19) United States
(12) Patent Application Publication
(10) Pub. No.: US 2013/0128769 A1
(43) Pub. Date: May 23, 2013

(54) METHOD OF GENERATING PARTITIONS OF A COMMUNICATIONS NETWORK, A NETWORK PARTITION GENERATOR AND A NETWORK

(71) Applicant: Chris H. Walshaw, London (GB)

(72) Inventor: Chris H. Walshaw, London (GB)

(73) Assignee: University of Greenwich, London (GB)

(21) Appl. No.: 13/698,534

(22) PCT Filed: May 13, 2011
(86) PCT No.: PCT/GB2011/050918

§ 371 Date: Feb. 4, 2013

(30) Foreign Application Priority Data
May 17, 2010 (GB) 1008217.0

(51) Int. Cl. H04W 16/22

(52) U.S. Cl. CPC H04W 16/22
USPC 370/254

(57) ABSTRACT

Method of generating partitions of a communications network A population of partitions S₀,S₁, . . . of a communication network (312) having different optimisation objectives are generated in a cascading manner. A preferred solution or partition can be selected from the population and the communications network (312) can be configured accordingly.

### FIELD

The present invention relates to a method of generating partitions of a communications network, a network partition generator, and a network.

### BACKGROUND

Typically, communications network resources, such as masts or base stations, are subdivided into a number of regions or cells. These regions are often, but not necessarily, geographically coherent. Division is either at the base station controller (“BSC”) level or the packet control unit (“PCU”) level, with each region assigned to a different controller or unit as the case may be.

It is not necessary for this subdivision into smaller regions to be optimised in order for the network to function. However, suboptimal network configurations typically require a much higher investment in terms of hardware infrastructure if they are to avoid dropped calls. Dropped calls can occur, for example, when a mobile communication device moves from one region to another. This type of movement is referred to as a “handover” from one control unit to another.

To find an optimal subdivision of the network, network resources and handover patterns can be represented by means of a network graph. Network information pertaining to handovers and call volume can be modeled by weights or values on the graph. The problem of optimising network resources can then be addressed by graph-partitioning techniques. In other words, network optimisation can be achieved by creating an optimal partition of the graph representing the network and then configuring the network accordingly. Optimising the partition can be undertaken by means of a technique called “graph-partitioning”, which is a well-known and well-developed field of mathematical optimisation.

There are many techniques and several open source or free software packages for graph partitioning and optimisation. Graph-partitioning is NP hard and so, for all but the smallest graphs, the techniques are necessarily heuristic in nature—i.e. they find a near-optimal partition rather than find the optimum. Typical software packages include: Metis (available from the Department of Computer Science and Engineering, University of Minnesota, 4-192 EE/CS Building, 200 Union Street SE, Minneapolis, Minn. 55455, USA), Chaco (available from the Discrete Algorithms & Math Department, Sandia National Laboratories, Albuquerque, N. Mex. 87185-1318, USA) and the inventor's own, Jostle (available from School of Computing and Mathematical Sciences, The University of Greenwich, Greenwich Campus, Old Royal Naval College, Greenwich, London, SE10 9LS, United Kingdom). Metis, for example, is widely used in many applications, most notably high-performance computing.

At the heart of these software packages is a technique known as “multilevel refinement” which has been around since 1993 and appears widely in academic literature. Although the multilevel refinement framework is common, each different software package that makes use of it uses a variety of different randomised “coarsening” and “optimization” heuristics. Each of these separate packages may, therefore, find slightly different solutions to the same initial optimisation problem. Indeed, by varying the seed for the underlying random number generator, any single package can find different solutions to the same initial problem if it is run multiple times through that package.

FIG. 1 shows a standard multilevel refinement 100 of an initial network graph 102 that calculates a partition into four parts or regions of the network graph using multilevel refinement, as would be expected from Metis, Chaco or Jostle.

The initial graph 102 includes a plurality of vertices 108, each typically representing a network site, such as mast or base station. The links between them, or edges 106, represent handovers from one site to another. Typically, multilevel refinement schemes match and coalesce or unify pairs of adjacent vertices to define a new graph having a smaller number of vertices and edges as can be seen on the top row of FIG. 1. This process is referred to as “coarsening” and serves to reduce the granularity or detail of the graph 102.

The coarsening procedure starts with an initial problem or graph 102 which is iteratively coarsened, one level, n, at a time, recursively until the overall graph size falls below some threshold and the “coarsest graph” 110 (shown at the top right of FIG. 1) is attained. At this stage, the coarsest graph 110 includes fewer vertices than there were in the graph 102 relating to the initial problem, but still includes a finite number of edges 112 and vertices 114.

The coarsest graph 110 is, thus, achieved by recursively coarsening the initial graph 102, to create ever smaller representations until some predetermined limit is reached. For example, the initial graph 102 is often coarsened to just one graph vertex per region.

The coarsest graph 110 is then partitioned to provide a “partitioned coarsest graph” 116 (shown on the bottom right of FIG. 1), so as to divide it up into a number of smaller partitions or problems. This partitioning may be by means of a crude algorithm. The partitioned coarsest graph 116 is then recursively uncoarsened, with the partition being refined at each level. A standard local search scheme such as the Fiduccia-Mattheyses algorithm can be used. Although the refinement is only local to each partition in nature, the multilevel framework gives a global view to the optimisation, resulting in a high quality final partition 118 (shown on the bottom left of FIG. 1).

In order to perform the refinement and uncoarsening, each partition of the partitioned coarsest graph 116 is successively uncoarsened (just by applying the calculated partition to the next level down) and then refined so that the overall graph becomes less coarse until a final result 118 at which the graph is of the same coarseness or granularity as the original graph is attained; except that it is made of multiple regions. At each change of level, n, in the un-coarsening process (process to return the partitioned coarsest graph 116 to its original granularity), the partition of the graph at one level n=i is used as the input for the next level n=i−1 of increased refinement (or decreased coarseness).

In terms of the exemplary network graph shown in FIG. 1, it is recalled that the top-leftmost graph 102 corresponds to the initial problem. The lower-leftmost graph 118 corresponds to the partitioned version of the original graph or problem 102.

As explained above, an optimized partition 118 is achieved by recursively coarsening the initial graph 102 to create ever smaller representations (left to right along the top row). Starting from left to right on the top row, the initial graph 102 is coarsened from an initial number of 45 vertices at the zeroth level (n=0, where n is the level of coarseness) to 25 vertices at the first level of coarsening (n=1), to 13 vertices at the second level of coarsening (n=2), to seven vertices at the third level of coarsening (n=3) and, finally, until there are only four remaining vertices 114 at the fourth and final level of coarsening (n=4). The graph at the fourth level (n=4) is the coarsest graph 110.

An initial partition 116 of the coarsest graph 110 is computed, for example by assigning one vertex to each region in the coarsest graph 110. In the partitioning step, the coarsest graph (i.e. where, in this example, n=4) is trivially partitioned into four separate sets as shown at the bottom right of FIG. 1 to provide a “partitioned coarsest graph” 116.

The partition of the coarsest graph 116 is then successively un-coarsened and refined, as shown on the bottom row from right to left. The lower-leftmost graph 118 shows the final solution, which is a partitioned version of the initial problem or graph 102. Although the refinement is only local in nature at each level, i.e. there are no global considerations, a high-quality partition 118 is still achieved.

The final partition 118 is shown at the bottom left of FIG. 1. The final partition 118 has 25 cut edges. The regions in the final partition 118 have 10, 11, 12 and 12 vertices.

The final partition contains 45 vertices and so this partitioning would be regarded as in perfect balance, since if there are 4 partitions, at least one of them must have 12 vertices. However, since we are typically concerned about the overloading of regions rather than underloading, splits of either 12,11,11,11 or 12,12,12,9 would be considered equally good.

In summary, in conventional network optimisation methods, graph-partitioning is represented by multilevel refinement techniques such as those discussed above. In addition, it is believed that some network operators are currently performing network optimisation which is manually instigated by means of field engineers.

Graph-partitioning in this sense is typically framed as a minimisation problem. The objective of the minimisation problem is to minimise the volume of inter-region handovers required. However, this is counter-balanced with a load-balancing constraint of distributing the call load across all the regions so they all have a roughly equal share of the network load. In terms of graph-partitioning, the aim is to split the initial graph 102 up into 4 regions so that the total number of cut edges 106 is minimised, subject to the constraint that each region should have as close to the same number of vertices 108 as possible. This can be restated as aiming for the partition to be “balanced”.

Imbalance in a partition is usually measured as a percentage and is calculated by dividing the number of vertices 120 in the largest partition 122 of the partitioned graph 118 by the number that would be in the largest partition of a perfectly balanced partition. For example, if an imbalanced partition based on the initial graph 102 of FIG. 1 had 15 vertices, then the imbalance is 15/12=1.25 or 25% imbalance. For 18 vertices, the imbalance is 18/12=1.50 or 50% imbalance.

Sometimes, the optimum network configuration is not based on a perfectly balanced solution, but one which has a certain degree of imbalance. By way of an example, if large numbers of mobile communications devices were moving within in a area (such as a motorway) handled by two neighbouring network regions, A, B, handover would be minimised, for example, if that area were managed by just one regional controller, A, even if the load on that controller were increased somewhat.

There is a trade-off between handover minimisation and call load balance and, if higher imbalance is allowable, for example 10-20% imbalance, then often a better minimisation can be found. If the partition is allowed to contain some imbalance, then there are often solutions with fewer cut edges (meaning that there is a lesser need for call handovers) than in the perfectly balanced solution. In the graph shown in FIG. 1, if one of the regions 122 in the refined partitioned graph 118 is allowed 15 vertices, then a partition with only 23 cut edges can be found. If one of the regions 122 in the refined partitioned graph 118 is allowed 18, then the graph 102 can be partitioned with just 20 cut edges. If perfect balance is not required, the problem is a trade-off between imbalance and edge cutting.

Thus, it will be seen that network optimisation does not necessarily mean minimising a single network parameter; some form of imbalance or trade-off may be required.

The interested reader is also referred to WO02104058, WO03037020 and WO03037020.

### SUMMARY OF INVENTION

According to a first aspect of the invention, there is provided a method of generating partitions of a communications network, the method comprising: providing a graphical representation of the communications network; generating a first, balanced partition of the communications network in which a network balancing constraint is imposed; and generating a second, imbalanced partition of the communications network in which the network balancing constraint is relaxed.

The graphical representation of the communications network may be an initial, unpartitioned representation of the communications network and the method may comprise: coarsening the initial, unpartitioned representation until a coarsened, unpartitioned representation is generated; partitioning the coarsened, unpartitioned representation to provide a coarsened, partitioned representation; and generating the first, balanced and second, imbalanced partitions of the communications network using the coarsened, partitioned representation.

Generating the first, balanced and second, imbalanced representations may comprise: generating a first, balanced refinement of a or the coarsened, partitioned representation in which the network balancing constraint is imposed; generating a first, imbalanced refinement of a or the coarsened, partitioned representation in which the network balancing constraint is relaxed; and further refining both the first, balanced and first, imbalanced refinements whereby to generate the first, balanced partition and the second, imbalanced partition of the communications network.

The generating may comprise: generating a second, balanced refinement of the first, balanced refinement in which the network balancing constraint is again imposed; generating a second, imbalanced refinement of the first, balanced refinement in which the network balancing constraint is relaxed; and further refining both the second, balanced and the second, imbalanced refinements to generate the first, balanced partition and a third, imbalanced partition of the communications network.

The communications network may be a mobile telecommunications network.

The graphical representation of the communications network may comprise a plurality of vertices corresponding to network sites in the communications network, and a plurality of edges corresponding to handovers between the network sites in the communications network.

The network balancing constraint may be a trade-off between inter-cell handover and network load distribution.

The network balancing constraint may be relaxed to up to a 40% imbalance to generate the second, imbalanced partition.

The network balancing constraint may be relaxed to up to a 20% imbalance to generate the second, imbalanced partition.

The method may comprise obtaining the graphical representation of the communications network.

The method may comprise optimising the network according to the partition that provides a desired network balance or imbalance.

According to a second aspect of the invention, there is provided a computer program comprising instructions which, when executed, cause a data processing apparatus to perform a method according to any preceding claim. The computer program may be stored on a computer-readable medium or may be carried by a signal.

According to a third aspect of the invention, there is provided a communications network optimised according to any of the above methods.

According to a fourth aspect of the invention, there is provided a network partition generator arranged to generate partitions of a communications network, the network partition generator being arranged to: provide a graphical representation of the communications network; generate a first, balanced partition of the communications network in which a network balancing constraint is imposed; and generate a second, imbalanced partition of the communications network in which the network balancing constraint is relaxed.

### BRIEF DESCRIPTION OF FIGURES

FIG. 1 shows a multilevel refinement of a network graph;

FIG. 2 shows a multilevel cascading; and

FIG. 3 is a schematic representation of a network partition generator.

### DETAILED DESCRIPTION

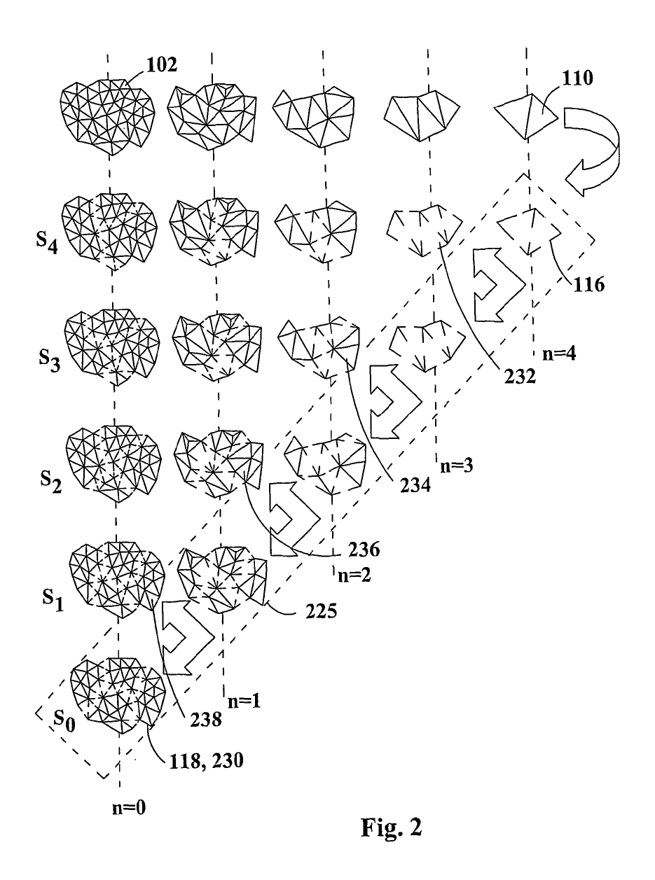

FIG. 2 shows schematically a method of generating partitions of a network according to one embodiment of the invention. In this embodiment, network constraint relaxation is used at each level, n, of uncoarsening. This involves allowing a network balancing constraint i.e. the call load balance, to be successively relaxed-in as the coarsening through the levels proceeds. This constraint is then tightened-up again, or balanced, as the optimisation proceeds back down through the levels and the graph is uncoarsened.

In the same manner as in conventional graph-partitioning techniques, the initial graph 102 or problem is coarsened from a zeroth level (n=0) to a fourth level (n=4) at which there are fewer vertices than there were in the initial problem. The coarsened graph at the fourth level (n=4) is, again, referred to as the “coarsest graph” 110.

Indeed, the refinement after partitioning of the coarsest graph 110 is initialised in the same way as it is implemented conventionally, i.e. by partitioning the coarsest graph 110 into a number of smaller graphs or problems to provide a partitioned coarsest graph 116.

However, in contrast to the conventional refinement technique, at every uncoarsening level or stage, n, two coarsened partitions are yielded.

One of the partitions, hereinafter referred to as the “balanced partition” 230, has the balancing constraint tightened at each level of refinement to as close to a 0% imbalance as possible. The balanced partition 230 corresponds to a conventional partition and is indicated by a diagonal series 225 of partitions in FIG. 2. However, an additional series of partitions hereinafter referred to as the “cascading partitions” 232, 234, 236, 238 are also retained and are allowed to maintain their imbalance as they are recursively refined to the zeroth level, n=0.

This results in a cascade of solutions, one extra for each level n, and hence a series of partitions S₀, S₁, S₂, S₃, S₄ for the same initial graph 102, trading-off imbalance against edge cut. S₀ represents a fully balanced solution. S₁ to S₄ have an increasing amount of network imbalance. The final partitions have, from the top (S₄) to bottom (S₀), 20, 23, 23, 25 and 25 cut edges. The largest number of vertices in any one region (the rightmost region in all cases) is, from the top (S₄) to the bottom (S₀) 18, 15, 14, 13 and 12. Since the maximum number of vertices in any one region in the balanced solution (in S₀) is 12, the imbalances are 50% (18/12), 25% (15/12), 16.6% (14/12), 8.3% (13/12) and 0% (12/12), respectively.

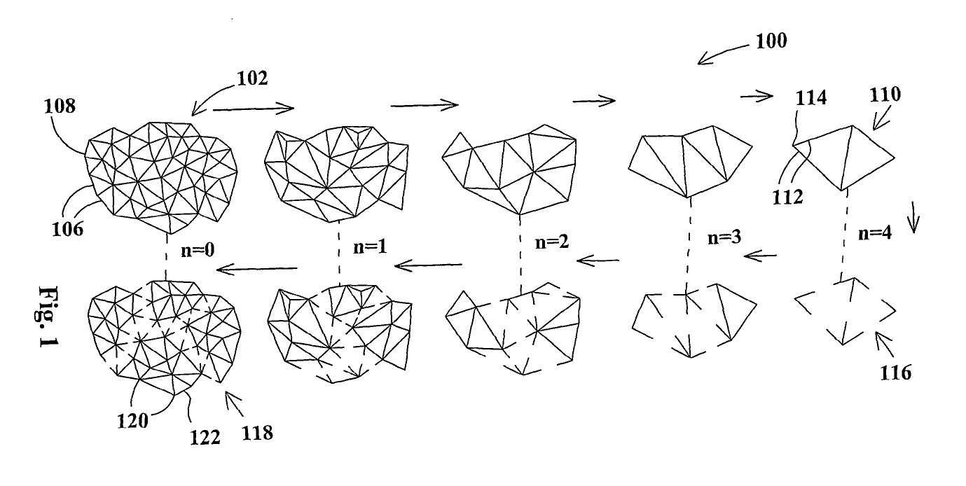

The schematic graphs shown in both FIGS. 1 and 2 are much smaller than would represent a typical mobile phone network. The results are, thus, more exaggerated. The mobile phone networks to which this technology can be applied in practice would have several hundred to several thousand vertices, each representing a physical network site, such as base station or mast. The coarsening could create 10-20 levels, n, of coarsening and refinement and, hence, 10-20 differently (im)balanced solutions S₀, S₁, . . . would result from the cascade. Furthermore, both the vertices and edges would have weights assigned to them, representing call load and call handovers, respectively, from one site or region to another. Thus, the network optimisation problem becomes one of balancing call load amongst the regions whilst minimising the volume of handovers. Imbalances of up to 20% or 40% might be suitable for partitioning a network in practice provided that they significantly reduced the number of handovers (or cut edges).

If a maximum imbalance of 20% were to be imposed, any of the bottom three partitions S₀, S₁, S₂ (having imbalances of 0%, 8.3% and 16.6% respectively) shown in FIG. 2 could be suitable. Since S₂ has only 23 cut edges, compared to 25 in both S₀ and S₁, it may represent a preferred network configuration. If a tightened balance of, say 10% were required, then only the most balanced solutions, S₀ and S₁, would be appropriate.

Thus, multilevel cascading procedure results in a series of partitions S₀, . . . , S₄ (one for each coarsening level n=0, . . . 4), which progressively trade off handover minimisation against load balance. Depending upon the particular network balance required—which can dynamically differ for a given network—the network operation has a choice of several network configurations from which one can be chosen as required.

The cascade S₀, . . . , S₄ of coarsened partitions can be assessed using standard multi-objective evolutionary techniques, which collectively treat the partitions as a population. In this context, the multilevel cascading acts as a diversity operator, adding variety to the population. In other words, the multilevel cascading provides several solutions to the initial problem 102, trading off load balance and call quality at each level.

These partitions can be assessed using standard multi-objective techniques which create a Pareto front of un-dominated solutions, i.e. those which are not dominated by other solutions in at least one of the criteria. The scheme can be represented in “pseudo-code” as:

```
for each random seed, s
    for each imbalance level allowable, i
        (if existing partition) for each migration target value, m
            calculate a partition, P(s, i, m)
            if the partition P(s, i, m) is un-dominated
                add it to the Pareto front
```

The best solutions to the problem are established by creating a Pareto front of un-dominated solutions. Subsequently, multilevel cascading is repeatedly applied to all un-dominated solutions until no further improvements in the Pareto front can be found.

The end result is a population of high-quality partitions targeting different optimisation objectives.

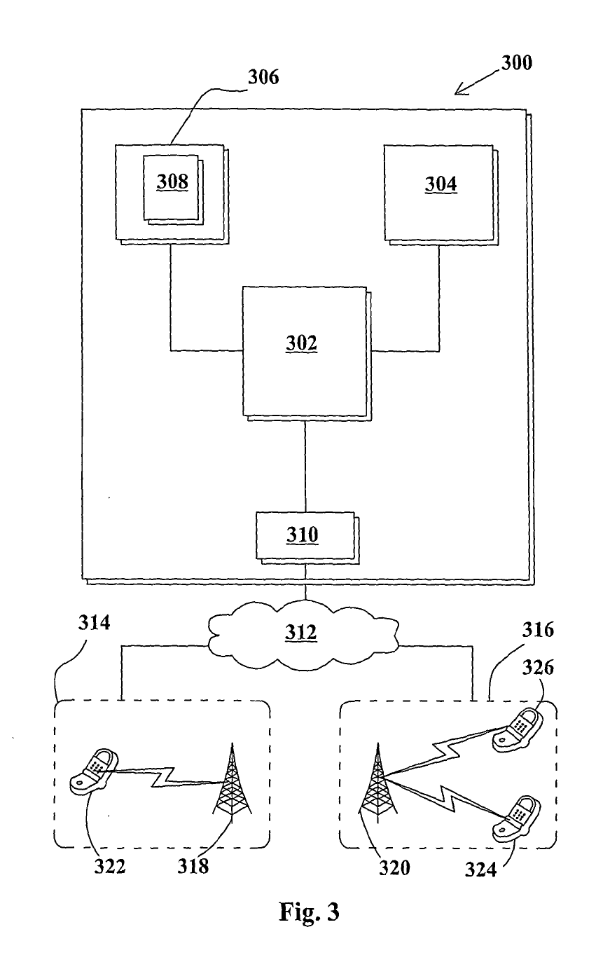

FIG. 3 shows, schematically, a network partition generator 300. The network partition generator 300 includes a controller 302 which communicates with a network partition engine 304 to generate possible network partitions. The network partition generator 300 also includes a memory 306 which can store, amongst other things, a computer program 308. The network partition generator 300 also includes a network interface which enables the network partition generator 300 to communicate with a mobile telecommunications network 312.

Two regions 314, 316 of the communications network 312 are shown. Each region includes a respective base station 318, 320 which communicates with respective mobile devices 322, and 324 and 326 in the regions 314, 316.

The network partition generator 300 operates as described above to generate a cascade of partitions of the network 312 trading off different optimisation objectives, such as load balance and handover minimisation. From the cascade of possible partitions, a preferred partition can be selected and the network 312 can be configured accordingly.

In summary, the present invention builds on the inherent capabilities of the multilevel framework to provide a population of solutions trading off different optimisation objectives from which a preferred solution or partition can be selected. The population can then be assessed using a standard multi-objective technique.

Alternatives

Possible network parameters to vary include, but are not limited to, the seed for the random number generator, the maximum allowable imbalance and, if an existing partition is known, the maximum migration required to reconfigure the network from the old to the new partitions. This can be an important consideration at higher levels of the network hierarchy where switching hardware from one region to another must be carried out manually.

Typically, these parameters are specified as a range, for example 0-40% imbalance, 0-50% migration. A representative set of these values can be chosen. Although the heuristic nature of graph-partitioning cannot give guarantees as to hitting a specific value, the multilevel framework allows the solution to be targeted towards them, for example via multilevel constraint relaxation.

1. A method of generating partitions of a communications network, the method comprising:
providing a graphical representation of the communications network;
generating a first, balanced partition of the communications network in which a network balancing constraint is imposed; and
generating a second, imbalanced partition of the communications network in which the network balancing constraint is relaxed.

2. The method according to claim 1, wherein the graphical representation of the communications network is an initial, unpartitioned representation of the communications network and wherein the method comprises:
coarsening the initial, unpartitioned representation until a coarsened, unpartitioned representation is generated;
partitioning the coarsened, unpartitioned representation to provide a coarsened, partitioned representation; and
generating the first, balanced and second, imbalanced partitions of the communications network using the coarsened, partitioned representation.

3. The method according to claim 1, wherein generating the first, balanced and second, imbalanced representations comprises:
generating a first, balanced refinement of a or the coarsened, partitioned representation in which the network balancing constraint is imposed;
generating a first, imbalanced refinement of a or the coarsened, partitioned representation in which the network balancing constraint is relaxed; and
further refining both the first, balanced and first, imbalanced refinements whereby to generate the first, balanced partition and the second, imbalanced partition of the communications network.

4. The method according to claim 3, further comprising:
generating a second, balanced refinement of the first, balanced refinement in which the network balancing constraint is again imposed;
generating a second, imbalanced refinement of the first, balanced refinement in which the network balancing constraint is relaxed; and
further refining both the second, balanced and the second, imbalanced refinements to generate the first, balanced partition and a third, imbalanced partition of the communications network.

5. The method according to claim 1, wherein the communications network is a mobile telecommunications network.

6. The method according to claim 5, wherein the graphical representation of the communications network comprises a plurality of vertices corresponding to network sites in the communications network, and a plurality of edges corresponding to handovers between the network sites in the communications network.

7. The method according to claim 6, wherein the network balancing constraint is a trade-off between inter-cell handover and network load distribution.

8. The method according to claim 5, wherein the network balancing constraint is relaxed to up to a 40% imbalance to generate the second, imbalanced partition.

9. The method according to claim 7, wherein the network balancing constraint is relaxed to up to a 20% imbalance to generate the second, imbalanced partition.

10. The method according to claim 1, comprising obtaining the graphical representation of the communications network.

11. The method according to claim 1, comprising optimising the network according to the partition that provides a desired network balance or imbalance.

12. A computer program comprising instructions which, when executed, cause a data processing apparatus to perform a method according to claim 1.

13. A communications network optimised according to the method of claim 1.

14. A network partition generator arranged to generate partitions of a communications network, the network partition generator being arranged to:
provide a graphical representation of the communications network;
generate a first, balanced partition of the communications network in which a network balancing constraint is imposed; and
generate a second, imbalanced partition of the communications network in which the network balancing constraint is relaxed.

15. (canceled)
